(19) United States
(12) Patent Application Publication
(10) Pub. No.: US 2007/0295556 A1
(43) Pub. Date: Dec. 27, 2007

(54) DEVICE SYSTEM AND METHOD OF ADJUSTABLE TELESCOPIC LEGS

(76) Inventor: Oded Grinberg, Mazkerer Batya (IL)

Correspondence Address: PAUL D. BIANCO: FLEIT, KAIN, GIBBONS,;GUTMAN, BONGINI, & BIANCO P.L., 21355 EAST DIXIE HIGHWAY, SUITE 115, MIAMI, FL, 33180, US

(21) Appl. No.: 11/425,722

(22) Filed: Jun. 22, 2006

(51) Int. Cl. E06C 7/00

(52) U.S. Cl. 182/201

(57) ABSTRACT

The present invention describes an adjustable telescopic leg system that is adapted to fit on at least one of a plurality of supporting side members that are connected to each other and rest on a ground surface. The adjustable telescopic leg system comprises at least one longitudinally adjustable telescopic leg having a sawtooth-like structure facing towards a latch. The sawtooth-like structure may be formed by a plurality of depressions on the adjustable telescopic leg. The latch may be adapted to fit tightly between an upper edge and a lower edge of the depressions. The adjustable telescopic leg system may further comprise a fixation rod connecting the latch with a release handle for longitudinally adjusting the position of the adjustable leg.

The release handle may have two positions: a locked position whereby the latch may be pressed against the depression when the release handle is in a straight position; and an unlocked position whereby the latch may be retracted from the depression when the release handle is in a tilted position.

### BACKGROUND OF THE INVENTION

Setting a ladder on an uneven surface causes the rungs of said ladder to become unleveled. In consequence, using the ladder may cause a safety problem, since a user, climbing up and down on the ladder, may lose balance and fall to the ground. Therefore, it may be useful to have a ladder having adjustable telescopic legs enabling approximate leveling of the rungs.

For example, telescopic legs may be implemented as presented by Convers et al., “Ladder which can be adapted for any surface”, patent number FR2701058, which is incorporated by reference for all purposes as if fully set forth herein. The invention presented by Convers et al. requires using two hands in order to longitudinally adjust a telescopic leg.

A telescopic leg may be implemented as presented by Bowman, “Telescopic leg ladder”, patent number US2002117355, which is incorporated by reference for all purposes as if fully set forth herein. Bowman et al. discloses securing a telescopic mechanism by use of a pin or other locking device. Therefore, the invention presented by Bowman requires using two hands in order to longitudinally adjust the telescopic leg. Furthermore, a user of Bowman's telescopic mechanism is required to verify that both a hole of the telescopic leg and a hole of a ladder leg are aligned.

A telescopic leg may be implemented as presented by Friedel “Self-leveling ladder”, U.S. Pat. No. 5,265,698, which is incorporated by reference for all purposes as if fully set forth herein. The telescopic leg presented by Friedel comprises a tension knob shaft inserted through a shaft and screwed into it. When the ladder is extended and locked in position, the tension knob shaft penetrates through the base of the female T-bolt. Therefore, a large moment may have to be applied on the tension knob in order to ensure locking of the telescopic leg. Furthermore, the user may have to bend over in order to adjust the telescopic leg.

A telescopic leg may be implemented as presented by Erkelenz, “Ladder for use on uneven surfaces—has ladder feet of adjustable length type, provided with elastic covering;”, patent number DE4035157, which is incorporated by reference for all purposes as if fully set forth herein. The invention described by Erkelenz requires the user to bend over and to use two hands in order to adjust said telescopic legs.

Another telescopic leg mechanism may be implemented as disclosed by Sheffield, U.S. Pat. No. 6,450,292, which is incorporated by reference for all purposes as if fully set forth herein. The invention described by Sheffield consists of an outer fixed housing, an internal telescopic extender and a ratchet mechanism, with teeth in the extender engaging with teeth attached to an arm which can rock about a pivot in the housing to disengage the opposing teeth. A roller or low friction device attached to the arm between the teeth and the pivot disengages the teeth during extending to reduce wear.

Another telescopic leg mechanism may be implemented as disclosed by Davies I., “Adjustable legs for a ladder”, patent number GB2197017, which is incorporated by reference for all purposes as if fully set forth herein. Davies' telescopic leg mechanism includes a clamp release lever that is attached to an eccentric bearing to provide a positive snap closing. When closed, a flat dog is engaged with slots cut into a front edge of an inner leg to hold it at the selected position. A user of the mechanism presented by Davies has to bend down in order to longitudinally adjust a telescopic leg incorporating said mechanism.

Another telescopic leg mechanism may be implemented as disclosed by Williams, “Leveler for ladders and other apparatus”, U.S. Pat. No. 4,770,275, which is incorporated by reference for all purposes as if fully set forth herein. One drawback of the telescopic leg mechanism is that when climbing up, ladder may tilt, thereby posing a safety problem. Another drawback is that the telescopic leg mechanism, as presented by Williams, can only be used on a pair of ladder legs.

Another telescopic leg mechanism may be implemented as disclosed by Goode, patent number EP0189929, which is incorporated by reference for all purposes as if fully set forth herein. One drawback of the mechanism presented by Goode is that a user of said mechanism has to bend down in order to longitudinally adjust a telescopic leg. Furthermore, a relatively large moment has to be applied on the clamping device in order to ensure locking of the telescopic leg.

### SUMMARY OF SOME EMBODIMENTS OF THE INVENTION

The present invention describes an adjustable telescopic leg system that is adapted to fit on at least one of a plurality of supporting side members that are connected to each other and rest on a ground surface. The adjustable telescopic leg system may comprise at least one longitudinally adjustable telescopic leg having a sawtooth-like structure facing towards a latch. The sawtooth-like structure may be formed by a plurality of depressions on the adjustable telescopic leg. The latch may be adapted to fit tightly between an upper edge and a lower edge of the depressions. The adjustable telescopic leg system may further comprise a fixation rod connecting the latch with a release handle for longitudinally adjusting the position of the adjustable leg. The release handle may have two positions: a locked position whereby the latch is pressed against the depression when the release handle is in a straight position; and an unlocked position whereby the latch is retracted from the depression when the release handle is in a tilted position. The supporting side members may be side members of a ladder.

The adjustable telescopic leg system may be adapted to fit within a shaft of each of the side members.

In another embodiment of the invention, the adjustable telescopic leg system may comprise two telescopic legs that are interconnected to each other by a mechanism (not shown); thereby enabling substantially simultaneous movement of the two telescopic legs.

The release handle may be located at a distance corresponding to the shoulder height of an average adult. The distance may be measured substantially between the latch and the release handle. The release handle may be rotatably connected to a handle housing having a slot. The release handle may include a safety catch, which may slide into and out of the slot. The release handle may become locked if the safety catch is within the slot. The release handle becomes unlocked if the safety catch is not within the slot. The safety catch may be connected by a return spring to the handle housing, thereby ensuring that the safety catch is by default inserted within the slot when the release handle is in the straight position. The upper edge may form an angle of approximately 45° relative to an imaginary axis C, which is perpendicular to a long edge of the telescopic leg. The lower edge may form an angle of approximately 45° relative to imaginary axis C. The telescopic leg may comprise a stopper to prevent the telescopic leg from sliding out of a side member's shaft. The fixation rod may have a decreased diameter at a lower end, thereby resulting in lower shoulders; and a decreased diameter at an upper end thereby resulting in upper shoulders. The upper shoulders may transmit a force to the lower shoulders, thereby resulting in a moment that presses the latch against the depression.

### BRIEF DESCRIPTION OF THE DRAWINGS

The subject matter regarded as the invention will become more clearly understood in light of the ensuing description of embodiments thereof, given by way of example only, with reference to the accompanying drawings, wherein

FIG. 1 is a schematic illustration of a ladder comprising adjustable telescopic legs resting on a surface in accordance with an embodiment of the invention;

FIG. 2A is a schematic illustration of a lengthwise cross-sectional view of an adjustable telescopic leg system depicting a release handle, being locked and in a straight position, in accordance with an embodiment of the invention;

FIG. 2B is a schematic illustration of an upper end of a fixation rod;

FIG. 2C is a schematic illustration of a lower end of a fixation rod;

FIG. 3 is a schematic illustration of a lengthwise cross-sectional side view of the release handle, said release handle being unlocked and in a straight position, in accordance with an embodiment of the invention;

FIG. 4 is a schematic illustration of a lengthwise cross-sectional side view of an adjustable telescopic leg system wherein the release handle is unlocked and in a tilted position;

FIG. 5 is a schematic illustration of a flowchart for adjusting and setting in place an adjustable telescopic leg;

FIG. 6 is a schematic illustration of perspective view of the release handle, viewed from the back, said release handle being unlocked and in a straight position, in accordance with an embodiment of the invention;

FIG. 7 is a schematic illustration of an perspective view of the release handle, viewed from the front, said release handle being unlocked and in the straight position, in accordance with an embodiment of the invention;

FIG. 8 is a schematic illustration of an perspective view of a leg-locking mechanism in accordance with an embodiment of the invention;

FIG. 9 is a schematic illustration of a perspective view of a portion of an adjustable telescopic leg, adjusted to a ladder leg, in accordance with an embodiment of the invention;

FIG. 10 is a schematic illustration of a widthwise cross-sectional view of a telescopic leg within a shaft of a ladder;

FIG. 11 is a schematic illustration of a release handle, being locked and in a straight position, in accordance with another embodiment of the invention;

FIG. 12 is a schematic illustration of a release handle, viewed from the back, said release handle being locked and in a straight position, in accordance to an embodiment of the invention; and

FIG. 13 is a schematic illustration of a leg-locking mechanism in accordance with another embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known devices, methods, procedures and/or components have not been described in detail so as not to obscure the invention.

The present invention is applicable to all types of ladders including industrial, commercial, and household ladders. For the purposes of this document, a ladder is defined as a portable structure comprising a plurality of side members that may be connected to each other by a variety of means, in a manner resulting in a variety of configurations. For example, a plurality of side members may be connected to each other by at least one horizontal rung or step, or may be connected to each other at substantially one point thereby forming a pyramid-like structure. For example, such a pyramid-like structure may be a tripod, which may support, for example, a camera, a machine gun, instruments for, e.g., geodesic measurements, or any other item that may need leveled positioning.

When in use, the portable structure is in a substantially upright position relative to a base surface. Such structures may include, for example, step ladders, straight ladders, extension ladders, combination ladders, trestle ladders, and the like. Moreover, although the drawings describe a stepladder, the present invention is applicable to any type of ladder or portable structure, as discussed above. Furthermore, the present invention is also applicable to portable structures that may hold a device that may be used for recreational activities such as, for example, a swing seat, a hammock, and the like.

The present invention relates to an adjustable telescopic leg system adapted in a manner so that the system may be detachably connected, adjusted and/or set in place to or within side members of, e.g., a ladder. Alternatively, the adjustable telescopic leg system may be an integral part of such a construction.

According to an embodiment of the invention, the adjustable telescopic leg system may include features or mechanical components or both that may enable a user of the telescopic leg system to longitudinally adjust or set in place at least one adjustable telescopic leg relative to a side member of, e.g., a ladder, while the user may be in a substantially upright standing position. Such a feature may be, for example, a sawtooth like structure on the adjustable telescopic leg, as will be outlined in detail below. Furthermore, a mechanical component may be, for example, a release handle connected by a mechanical transmission mechanism to another component such as a leg-locking mechanism. The leg locking mechanism may include, for example, a latch, that may set in place or release a telescopic leg by inserting or retracting the latch, respectively, to or from a depression of the sawtooth-like structure. Inserting the latch into a depression may be accomplished by turning the release handle into a straight position. The adjustable telescopic leg may then be set in place by locking the release handle, as will be outlined below in detail with reference to the figures. Conversely, retracting of the latch may be accomplished by first unlocking the release handle and then by turning the latch into a tilted position as will be outlined below in detail with reference to the figures.

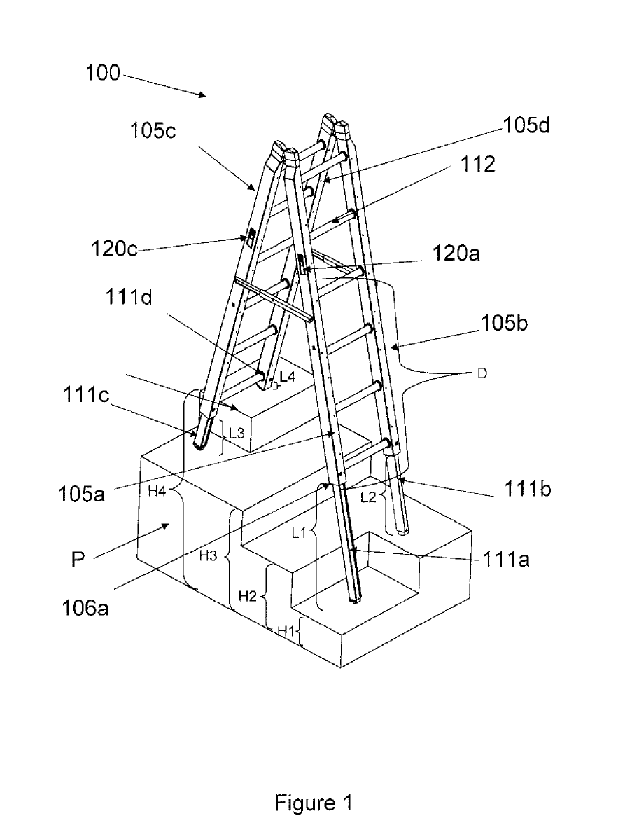

Reference is made to FIG. 1, which schematically illustrates a ladder comprising adjustable telescopic legs resting on a surface in accordance with an embodiment of the invention.

According to an embodiment of the invention, a ladder 100 may include one or more telescopic legs that may be adjusted at or fitted within each shaft of ladder legs. For example, a ladder leg 105a may comprise a shaft 199a wherein telescopic leg 111a may be fitted. Furthermore, telescopic legs 111a, 111b, 111c and 111d may be displaced longitudinally and set in place relative to ladder legs 105a, 105b, 105c and 105d, respectively, as will be outlined in detail below. Therefore, ladder 100 may be positioned on, for example, an uneven surface or on a platform P that may have, for example, four different heights denoted as H1, H2, H3 and H4, whereas H1<H2<H3<H4. Accordingly, telescopic legs 111a, 111b, 111c and 111d may be adjusted to lengths L1, L2, L3 and L4, whereas L1>L2>L3>L4, while each adjusted length may compensate for the different heights H1, H2, H3 and H4. Accordingly, rung(s) 112 of ladder 100 may remain in a substantially horizontal position.

According to an embodiment of the invention, longitudinal displacement of, e.g., telescopic leg 111a may be enabled by unlocking a release handle 120a, whereas the setting in place of ladder leg 111a may be enabled by the locking of release handle 120a, as will be explained in detail below. Moreover, release handle 120a may be located at various heights along ladder leg 105a, as will be outlined below, thereby facilitating positioning of ladder 100 onto an uneven surface. For example, release handle 120a may be located at a distance D measured, for example, between substantially vertically from a lower end 106a of ladder leg 105a. Distance D may be, e.g., 150 cm, 160 cm, 165 cm and the like and/or may substantially correspond to an average adult's shoulder height, elbow height and the like or any other distance that may facilitate positioning of ladder 100 onto an uneven surface. Distance D may depend on a length of a fixation rod connecting between release handle 120a and a latch, as will be outlined in detail below.

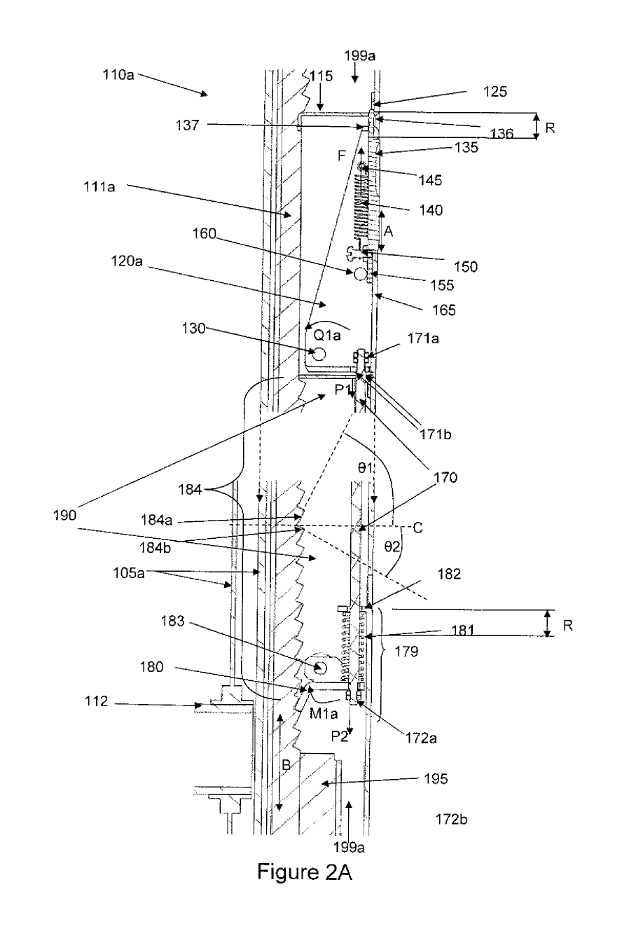

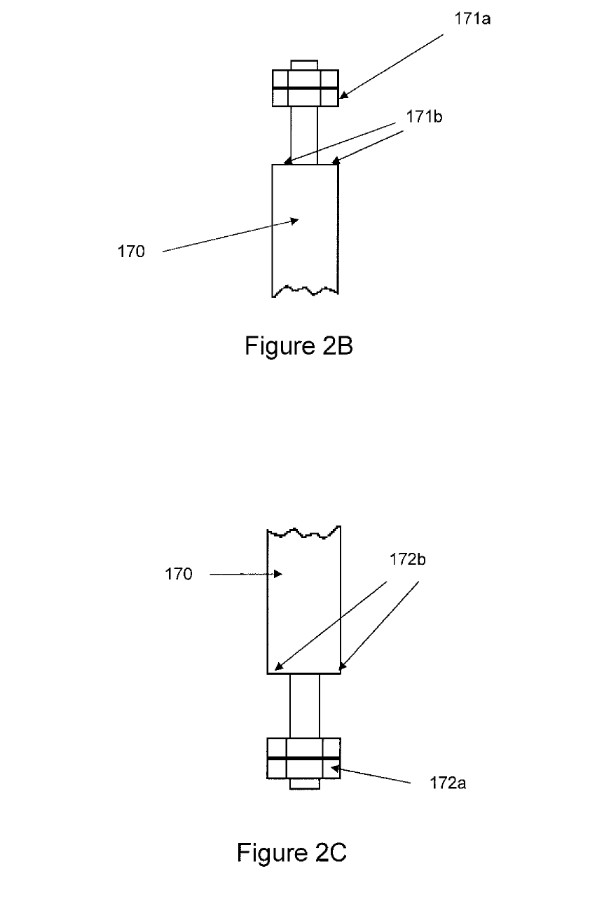

Reference is made to FIG. 2A, which schematically illustrates a lengthwise cross-sectional view of an adjustable telescopic leg system depicting a release handle, locked and in a straight position, in accordance with an embodiment of the invention.

A telescopic leg system, e.g. telescopic leg system 110a, may comprise a handle housing 115 embedding therein release handle 120a. Release handle 120a may be rotatably connected to handle housing 115 by, e.g., a hinge 130.

According to an embodiment of the invention, release handle 120a is either in an straight or in a tilted position. In the straight position, release handle 120a is either locked or unlocked. When unlocked, release handle 120a may be able to rotate around hinge 130, as schematically indicated by arrow Q1a, from the straight position to the tilted position and vice versa. If release handle 120a is locked, it may be prevented from rotating around hinge 130. Whether release handle 120a may be able to rotate around hinge 130 or not may depend on the position of a safety catch 135, which is included in release handle 120a as will be outlined in detail below.

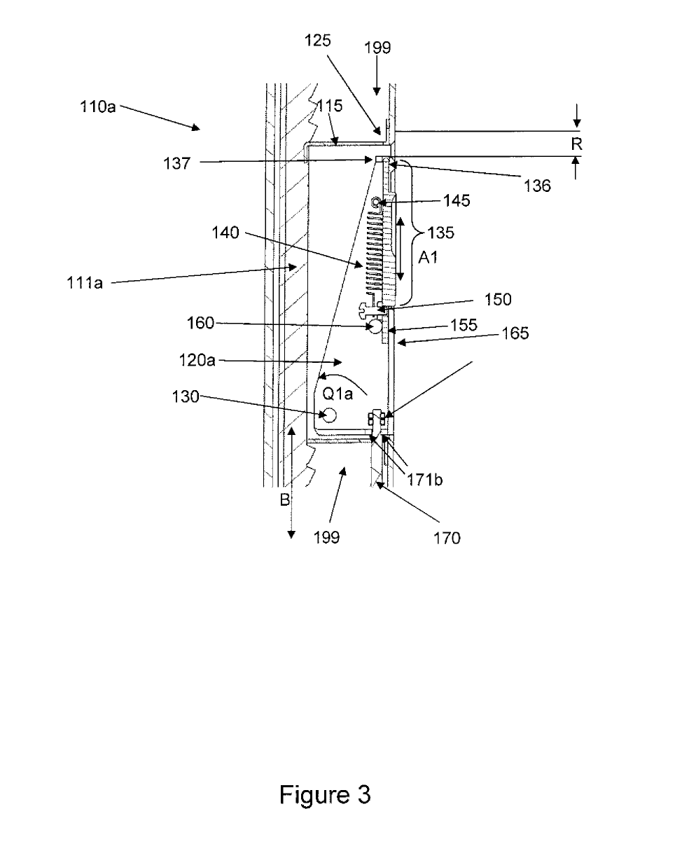

According to an embodiment of the invention, handle housing 115 may include a slot 125 into and out from which an upper tip 136 of safety catch 135 may slide. If upper tip 136 of the safety catch 135 is inserted into slot 125, release handle 120a may be prevented from rotating around hinge 130 and is therefore locked. Conversely, as indicated in FIG. 3, if upper tip 136 of the safety catch 135 is not inserted within slot 125, release handle 120a may rotate around hinge 130 as schematically indicated with arrow Q1a. If release handle 120a rotates around hinge 130, said release handle may be defined as being unlocked.

Referring again to FIG. 2A, release handle 120a may include, according to an embodiment of the invention, a return spring 140 that may ensure that when release handle 120a is in the straight position, said release handle 120a will be locked by default as will be outlined hereinafter. An upper part of return spring 140 may be wound around a pin 145, which may be integrated into release handle 120a. Furthermore, a lower part of return spring 140 may be connected via a screw 150 to safety catch 135. As a consequence, safety catch 135 may be linked via return spring 140 to release handle 120a. Return spring 140 may be adapted to exert a force, as schematically indicated with arrow F, onto safety catch 135. Accordingly, return spring 140 may ensure that upper tip 136 of safety catch 135 may be inserted in slot 125 of handle housing 115, if no counter force exceeding force F is applied. Consequently, the release handle's 120a default position may be the locked position. It may be noted that by displacing safety catch 135 downward, the force F may increase as a function of the amount of safety catch's 135 longitudinal downward displacement.

According to an embodiment of the invention, an upper part of safety catch 135 may be embedded within a track 137. Moreover, a lower part 155 of safety catch 135 may be confined between a stopper 160 and an outer wall 165 of release handle 120a. Therefore, safety catch 135 may be confined to move in a longitudinal direction along the outer wall 165 of handle housing 115, as schematically indicated with arrow A1.

According to an embodiment of the invention, a fixation rod 170 may be linked to release handle 120a via an upper hook 171a. Distance D of release handle 120a, which may be measured substantially vertically from lower end 106a of ladder leg 105a, may depend on the length of fixation rod 170.

Fixation rod 170 may have a leg locking mechanism 179 adjusted thereto, which may include a latch 180. Latch 180 may be set between lower hook 172a and lower shoulders 172b. Furthermore, fixation rod 170 may be substantially confined within a ring-like guide 182. Accordingly, fixation rod 170 may only move in a substantially longitudinal direction.

A return spring 181 may be wound around the lower end of fixation rod 170 between ring-like guide 182 and latch 180. Moreover, latch 180 may be rotatably connected to a wall 190 of telescopic leg system 110a by, for example, a hinge 183. Consequently, latch 180 may be pressed, by return spring 181 against ring-like guide 182.

Reference is now made to FIGS. 2B and 2C. The diameter or thickness of the upper and lower ends of rod 170 may decrease, resulting in upper shoulders 171b and lower shoulders 172b, respectively.

Reference is now made again to FIG. 2A. When in the straight position, release handle 120a may apply a force P1 on shoulders 171b, resulting in a force P2 on shoulder 172b. Force P2 applied on shoulder 172b may result in a moment M1a around hinge 183, thereby pressing latch 180 against a depression of sawteeth 184. Moreover, when the user rests on a rung of ladder 105a, a lower edge, e.g., lower edge 184b, will be pressed against latch 180.

According to an embodiment of the invention, telescopic leg 111a may be confined by ladder leg 105a. As a consequence, telescopic leg 111a may be confined to moving in a longitudinal direction along ladder leg 105a, as schematically indicated with arrow B. Furthermore, telescopic leg 111a may have a sawtooth-like structure, hereinafter referred to as “sawteeth 184”, facing towards latch 180 along the long edge of some portion of telescopic leg 111a. Sawteeth 184 may extend to a section 195 of telescopic leg 105 that does not have sawteeth 184. Sawteeth 184 may be formed by a plurality of depressions, while each depression may have an upper edge 184a and a lower edge 184b. Upper edge 184a may be tilted upwardly with regard to an imaginary axis C. The imaginary axis C may be perpendicular to the direction of longitudinal displacement, which is schematically indicated with arrow B, of telescopic leg 111a.

Upper edge 184a may be tilted upwardly with regard to imaginary axis C, thereby forming an angle θ1 having values of, for example, 30 degrees, 35 degrees, 45 degrees, or 60 degrees, with regard to imaginary axis C, or any other value providing tight support for latch 180. Lower edge 184b may be tilted downwardly with regard to imaginary axis C, thereby forming an angle θ2 having values of, for example, 0 degrees, 30 degrees 45 or any other value suitable for providing tight support for latch 180. Thus configured, telescopic leg 111a cannot move longitudinally if release handle 120a is in the locked position.

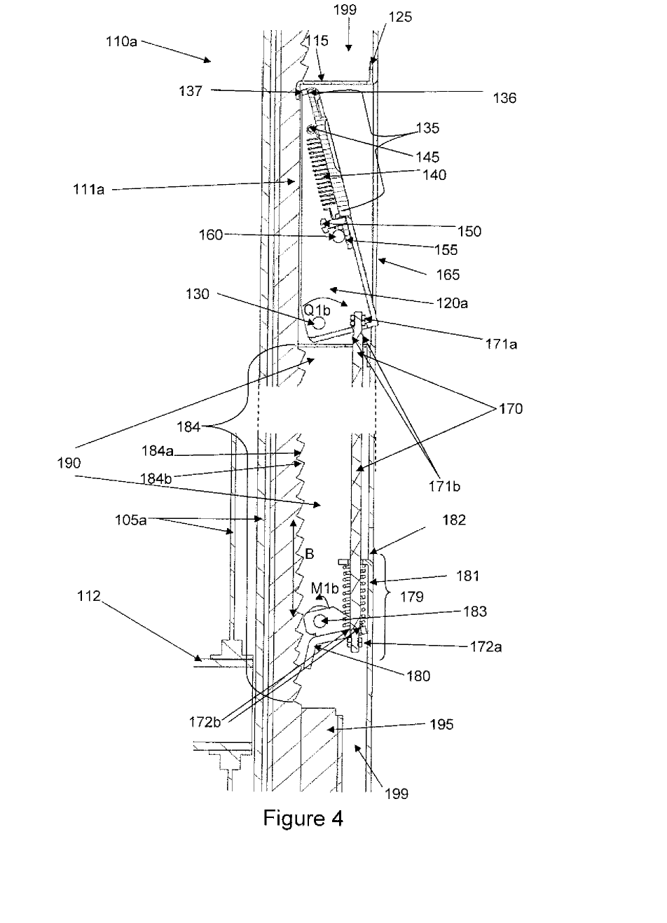

According to an embodiment of the invention, latch 180 may be adapted to fit tightly between upper edge 184a and lower edge 184b. For example, when release handle 120a is in the straight position, latch 180 may be inserted between upper edge 184a and lower edge 184b. Furthermore, if release handle 120a is also in the locked position, i.e., release handle 120a cannot rotate around hinge 130, latch 180 may be prevented from rotating around hinge 183. As consequence, telescopic leg 111a may be set in place. Conversely, if release handle 120a is in the tilted position, telescopic leg 111a may be set in place with regard to longitudinal motion relative to, e.g., ladder leg 105a, as will be outlined in detail below with reference to FIG. 4.

Reference is now made to FIG. 4, which schematically illustrates a cross-sectional side view of an adjustable telescopic leg system wherein the release handle is unlocked and in a tilted position.

According to an embodiment of the invention, safety catch 135 may be displaced from the locked position (see FIG. 2A), to the unlocked position (see FIG. 3). Therefore, release handle 120a may be tilted from a straight to a tilted position as schematically indicated with arrow Q1a. Turning release handle 120a from the straight to the tilted position, results in pulling fixation rod 170 upwardly through hook 171a. In turn, hook 172a pulls latch 180, resulting in a moment M1b. Therefore, latch 180 may be retracted from sawteeth 184. As a result, telescopic leg 111a may move longitudinally within shaft 199a.

In consequence, telescopic leg 111a may move freely in a longitudinal direction along, e.g., ladder leg 105a, as schematically indicated with arrow B. Therefore, telescopic leg 111a may be adjusted longitudinally relative to ladder leg 105a. In order to set telescopic leg 111a again in place after adjustment, release handle 120a may be turned from the tilted position to the straight position as schematically indicated with arrow Q1b.

Referring again to FIG. 3, upon releasing of release handle 120a, return spring 181 presses against latch ring-like guide 182. In turn, return spring 181 presses against latch 180, which in consequence presses against lower hook 172a. In turn, fixation rod 170 is pulled downward by return spring 181. As a result, upper hook 171a pulls release handle 120a down, which causes release handle 120a to turn around hinge 130 into the straight position. It may be noted that in the straight position, mere releasing of safety catch 135, locks release handle 120. This, since return spring 140 applies a force F upwardly on safety catch 135, forcing safety catch 135 to move into slot 125, as already mentioned above.

According to some embodiments of the invention, after using ladder 100 on an uneven surface, telescopic legs, e.g., telescopic leg 111a may be inserted or stowed back into shaft 199a. This may be accomplished by unlocking of release handle 120a, pushing telescopic leg 111a back to shaft 199a. Release handle 120a may then be locked in order to avoid from telescopic leg 111a to slide out of shaft 199a.

According to an embodiment of the invention, components of a telescopic leg system, e.g., telescopic leg system 110a, may be made of various materials such as metallic materials, e.g., aluminum, or any other suitable material.

According to an embodiment of the invention, telescopic leg 111a may include a brush (not shown). In consequence, dust, dirt and the like may be removed from shaft 199a of ladder leg 105a when displacing telescopic legs 111a longitudinally within said shaft 199a.

According to an embodiment of the invention, two telescopic legs, e.g., telescopic leg 111a and 111b, may be interconnected to each other, thereby enabling substantially simultaneous movement of telescopic leg 111a and 111b.

According to some embodiments of the invention, a level device may be used to indicate whether ladder 100 is leveled. Such a level device may be positioned, for example, on top of ladder 100, attached on one of the rungs of ladder 100 or at any other position enabling determining whether ladder 100 is leveled.

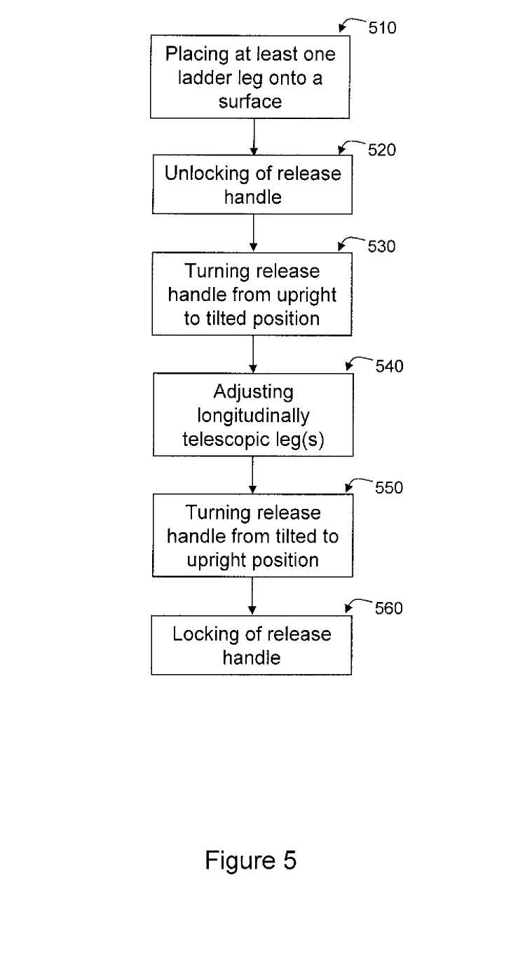

Reference is now made to FIG. 5, which schematically illustrates a method for adjusting and setting in place a telescopic leg according to an embodiment of the invention.

As indicated at box 510, the method may include placing at least one side member that may be, e.g., ladder leg 105d, onto a section of surface P having the highest elevation.

As indicated at box 520, the method may include unlocking of a release handle, e.g., release handle 120a. Unlocking of release handle 120a may be accomplished by sliding safety catch 135 out of slot 125.

As indicated at box 530, the method may include turning of a release handle, e.g., release handle 120a from the straight to the tilted position.

As indicated at box 540, the method may include adjusting longitudinally telescopic leg(s). For example, telescopic legs 111a may be adjusted longitudinally relative to ladder legs 105b, 105c and 105d, respectively.

As indicated at box 550, the method may include turning a release handle that may be, e.g., release handle 120a, from the tilted to the straight position.

As indicated at box 560, the method may include locking a release handle that may be, e.g., release handle 120a. Locking of release handle 120a may be accomplished by inserting safety catch 135 into slot 125.

It may be noted that in case additional legs are to be longitudinally adjusted, steps 520 to 560 may be repeated.

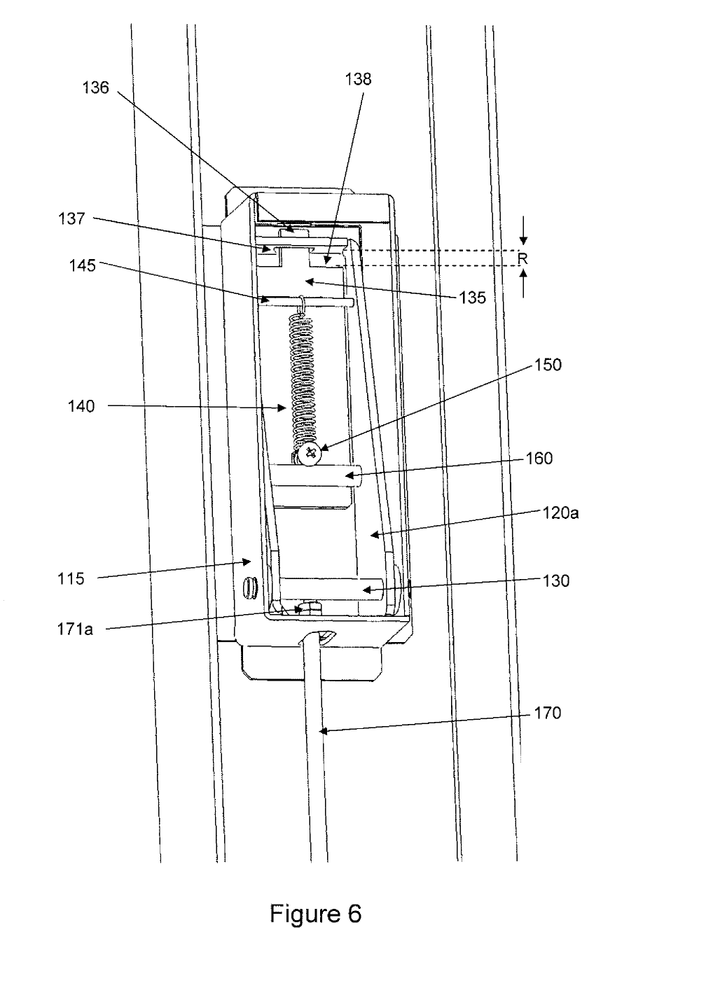

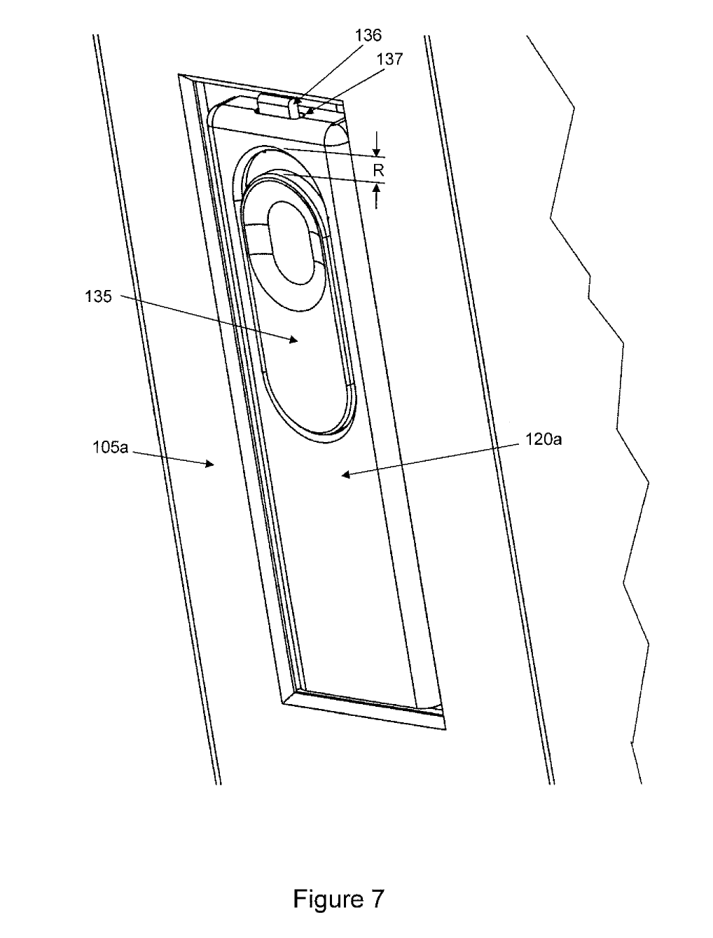

FIG. 6 schematically illustrates a perspective view of the release handle, viewed from the back, said release handle being unlocked and in a straight position, in accordance with an embodiment of the invention.

According to some embodiments of the invention stopper 138 may be used to limit longitudinal upward displacement of safety catch 135. Stopper 160 on release handle 120a may also be used to limit the longitudinal downward displacement of safety catch 135. The distance of possible longitudinal displacement of safety catch 135 is schematically indicated with arrow R.

FIG. 7 schematically illustrates a perspective view of the release handle, viewed from the front, said release handle being unlocked and in the straight position, in accordance with an embodiment of the invention.

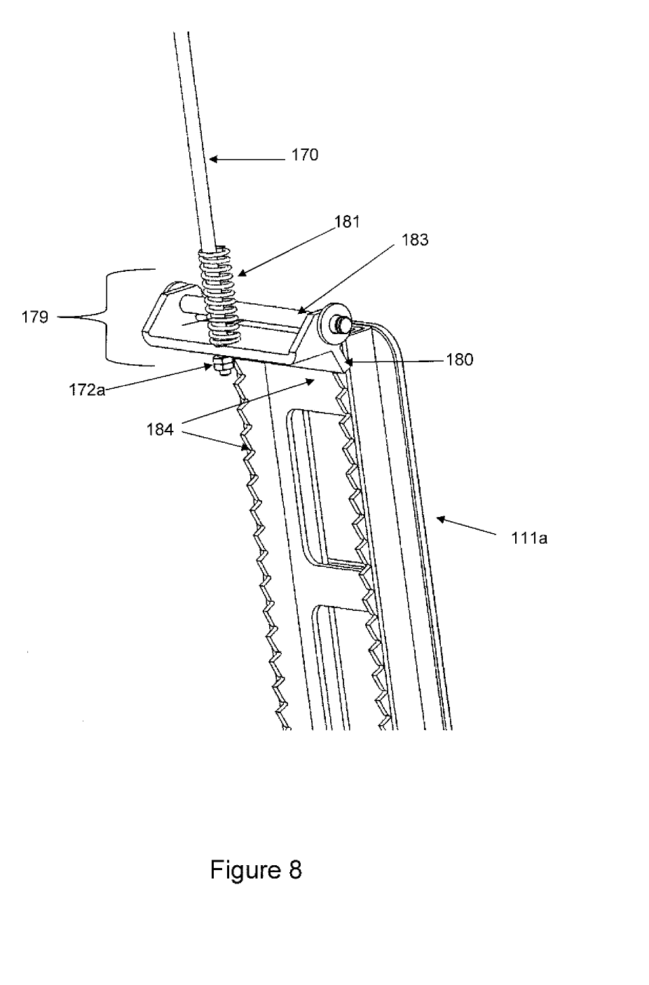

FIG. 8 schematically illustrates a perspective view of a leg-locking mechanism, in accordance with an embodiment of the invention.

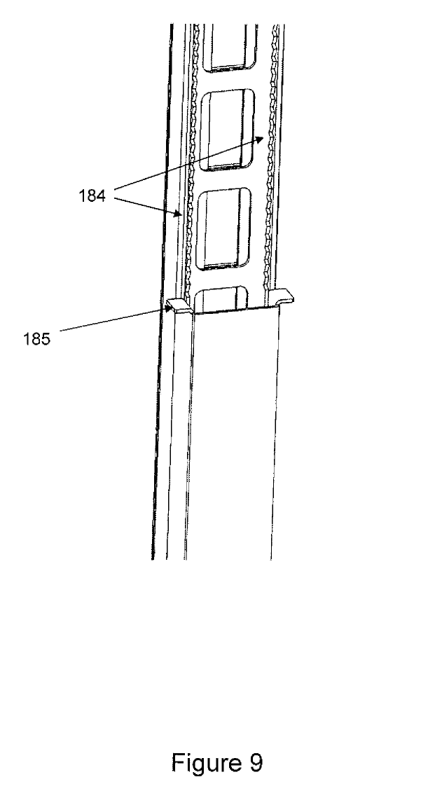

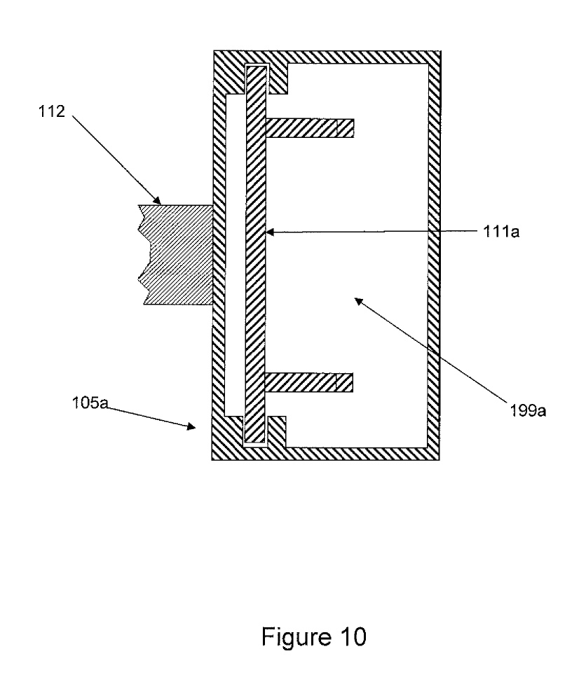

FIG. 9 schematically illustrates a perspective view of a portion of an adjustable telescopic leg, adjusted to a ladder leg, in accordance with an embodiment of the invention.

Telescopic leg 111a may have a stopper 185 that may prevent telescopic leg 111a to slide out of ladder leg 105a.

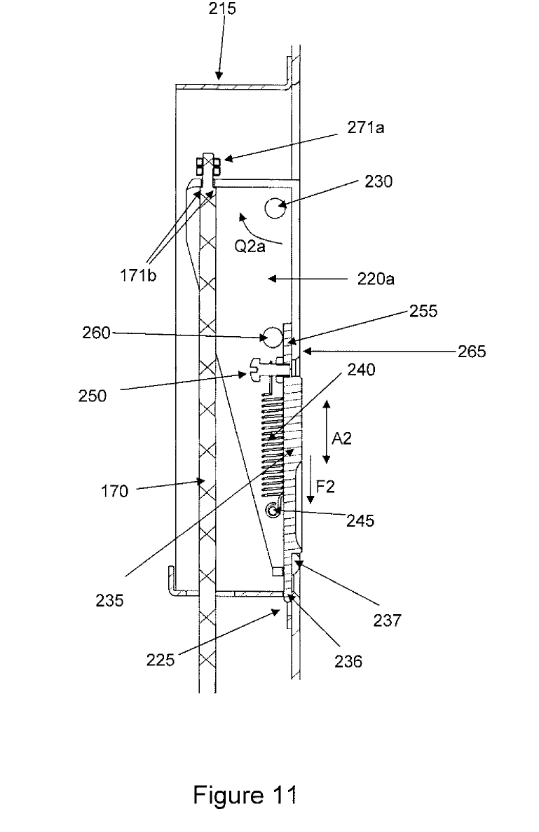

Reference is now made to FIG. 11, which schematically illustrates a release handle being locked and in a straight position, in accordance with another embodiment of the invention.

According to some embodiments of the invention, a telescopic leg system 110a may further comprise a release handle 220a, which is configured substantially like release handle 120a, but turned upside-down.

According to an embodiment of the invention, release handle 220a may be either in a straight or in a tilted position. In the straight position, release handle 220a is either locked or unlocked. When unlocked, release handle 220a may be able to rotate around hinge 230, as schematically indicated by arrow Q2a, from the straight position to the tilted position and vice versa. If release handle 220a is locked, it may be prevented from rotating around hinge 230. Whether release handle 220a is able to rotate around hinge 230 or not may depend on the position of a safety catch 235, which is included in release handle 220a as will be outlined in detail below.

According to an embodiment of the invention, a handle housing 215 may include a slot 225 into and out from which a lower tip 236 of safety catch 235 may slide. If lower tip 236 of the safety catch 235 is inserted into slot 225, release handle 220a may be prevented from rotating around hinge 230 and is therefore locked. Conversely, if lower tip 236 of the safety catch 235 is not inserted within slot 225, release handle 220a may rotate around hinge 230 as schematically indicated with arrow Q2a. If release handle 220a rotates around hinge 230, said release handle may be defined as being unlocked.

Release handle 220a may include, according to an embodiment of the invention, a return spring 240 that may ensure that when release handle 220a is in the straight position, said release handle 220a will be locked by default as will be outlined hereinafter. A lower part of return spring 240 may be wound around a pin 245, which may be integrated into release handle 220a. Furthermore, an upper part of return spring 240 may be connected via a screw 250 to safety catch 235. As a consequence, safety catch 235 may be linked via return spring 240 to release handle 220a. Return spring 240 may be adapted to exert a force, as schematically indicated with arrow F2, onto safety catch 235. Accordingly, return spring 240 may ensure that lower tip 236 of safety catch 235 may be inserted into slot 225 of handle housing 215, if no counter force exceeding force F2 is applied. Consequently, the release handle's 220a default position may be the locked position. It may be noted that by displacing safety catch 235 upward, force F2 may increase as a function of the amount of safety catch's 235 longitudinal upward displacement.

According to an embodiment of the invention, an upper part of safety catch 235 may be embedded within a track 237. Moreover, a lower part 255 of safety catch 235 may be confined between a stopper 260 and an outer wall 265 of handle housing 215. Therefore, safety catch 235 may be confined to moving in a longitudinal direction along the outer wall 265 of handle housing 215, as schematically indicated with arrow A2. Fixation rod 170 may be linked to release handle 220a via an upper hook 171a, thereby enabling substantially the same functionality as with release handle 120a.

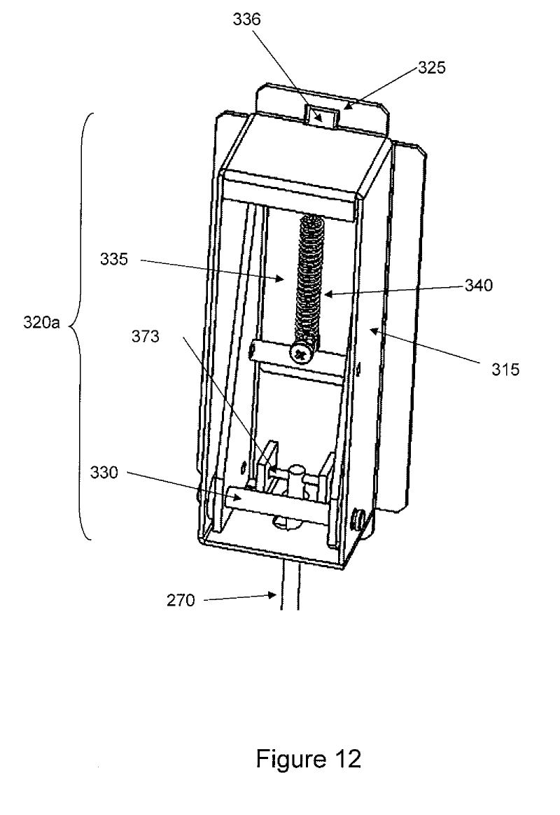

Reference is now made to FIG. 12, which schematically illustrates a release handle from the back, said release handle being locked and in a straight position, in accordance to yet another embodiment of the invention.

According to some embodiments of the invention, a telescopic leg system 111a includes a release handle 320a, which is configured similarly to release handle 120a. A possible distinguishing feature between release handles 320a and 120a may be that a fixation rod 270 may be connected to release handle 320a via a pin 373, whereas fixation rod 170 is connected to release handle 120a via a hook such as, e.g., upper hook 171.

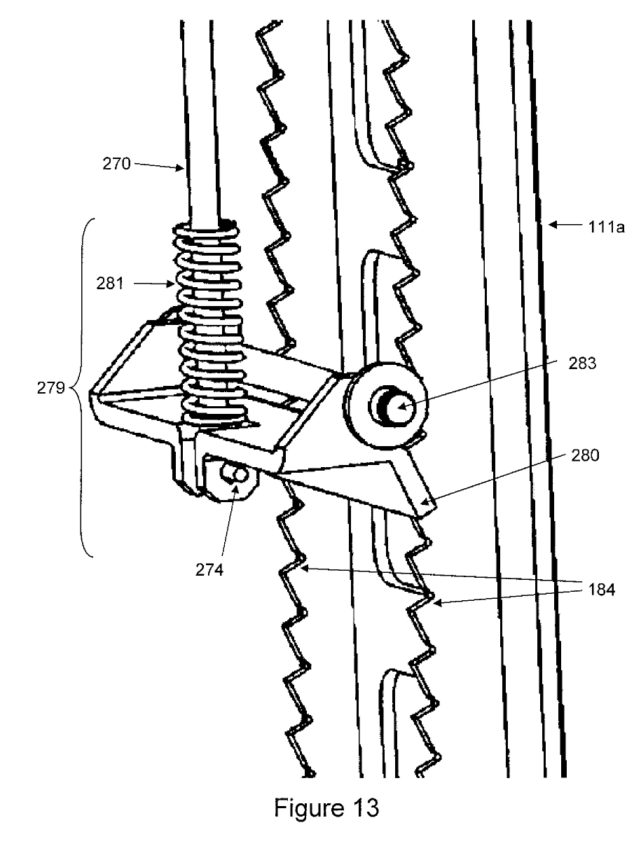

Reference is now made to FIG. 13, which schematically illustrates a leg-locking mechanism in accordance with another embodiment of the invention.

According to some embodiments of the invention, a telescopic leg system 111a includes a leg locking mechanism 279, which is configured similarly to leg-locking mechanism 179. A possible distinguishing feature between leg locking mechanisms 279 and 179 may be that fixation rod 270 may be connected to leg-locking mechanism 279 via a pin 274 rather than via a hook such as, e.g., lower hook 172a.

While the invention has been described with respect to a limited number of embodiments, these should not be construed as limitations on the scope of the invention, but rather as exemplifications of some of the possible embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. An adjustable telescopic leg system that is adapted to fit on at least one of a plurality of supporting side members, said side members being connected to each other and resting on a ground surface, said system comprising:
a) at least one longitudinally adjustable telescopic leg having a sawtooth-like structure facing towards a latch, said structure formed by a plurality of depressions on the adjustable telescopic leg, said latch adapted to fit tightly between an upper edge and a lower edge of said depressions; and
b) a fixation rod connecting said latch with a release handle for longitudinally adjusting the position of said adjustable telescopic leg, said release handle, having two positions:
i. a locked position whereby said latch is pressed against said depression when said release handle is in a straight position; and
ii. an unlocked position whereby said latch is retracted from said depression when said release handle is in a tilted position.

2. The adjustable telescopic leg system of claim 1, wherein said supporting side members are side members of a ladder.

3. The adjustable telescopic leg system of claim 1 that is adapted to fit within a shaft of each of said side members.

4. The adjustable telescopic leg system of claim 1 comprising two telescopic legs that are interconnected to each other, thereby enabling substantially simultaneous movement of said two telescopic legs.

5. The adjustable telescopic leg system of claim 1, wherein said release handle is located at a distance corresponding to the height of an average adult, said distance being measured substantially between the latch and the release handle.

6. The adjustable telescopic leg system of claim 1, wherein said release handle is rotatably connected to a handle housing having a slot.

7. The adjustable telescopic leg system of claim 1, wherein said release handle includes a safety catch which can slide into and out of said slot.

8. The adjustable telescopic leg system of claim 1, wherein said release handle becomes locked if said safety catch is within said slot.

9. The adjustable telescopic leg system of claim 1, wherein said release handle becomes unlocked if said safety catch is not within said slot.

10. The adjustable telescopic leg system of claim 1, wherein said safety catch is further connected by a return spring to said handle housing thereby ensuring that said safety catch is by default inserted within said slot when said release handle is in said straight position.

11. The adjustable telescopic leg system of claim 17 wherein said upper edge forms an angle of approximately 45° relative to an imaginary axis C, which is perpendicular to a long edge of said telescopic leg.

12. The adjustable telescopic leg system of claim 1, wherein said lower edge forms an angle of approximately 45° relative to said imaginary axis C.

13. The adjustable telescopic leg system of claim 1, wherein said telescopic leg comprises a stopper to prevent the telescopic leg from sliding out of a side member's shaft.

14. The adjustable telescopic leg system of claim 1, wherein said fixation rod has:
a. a decreased diameter at a lower end, thereby resulting in lower shoulders; and
b. a decreased diameter at an upper end thereby resulting in upper shoulders;
i. said upper shoulders transmitting a force to lower shoulders, said force causing a moment that presses said latch against said depression.
